(19) United States
(12) Patent Application Publication
(10) Pub. No.: US 2003/0225853 A1
(43) Pub. Date: Dec. 4, 2003

(54) Method and system for constructing a database-driven website

(76) Inventors: John Y. Wang, Livermore, CA (US); Evan Y. Wang, Fremont, CA (US)

Correspondence Address: SAWYER LAW GROUP LLP, P.O. Box 51418, Palo Alto, CA, 94303, US

(21) Appl. No.: 10/004,014

(22) Filed: Oct. 18, 2001

(51) Int. Cl. G06F 15/16

(52) U.S. Cl. 709/217

(57) ABSTRACT

A method and system for constructing a database driven website is disclosed. The method and system include storing each web page as a database record having fields that reference a layout template and content, and storing the layout template and the content as database records. The method and system further include displaying each web page by using the fields in the corresponding database record to access the layout template and content records for display.

### FIELD OF THE INVENTION

The present invention relates to website construction, and more particularly to a method and system for constructing a database-driven website.

### BACKGROUND OF THE INVENTION

Creating a website is typically a step-by-step process, which includes planning, designing, and coding. The purpose and overall content for the website is defined during the planning phase, while the overall layout and organization of the website, starting with the homepage, is developed in the design phase. Defining the layout of a website may include defining colors, graphical elements and standard navigational elements that are displayed in navigational headers and footers. The navigational elements for the website may include text links, a navigation bar, and a site map. In most cases, the layout places global navigational elements along the top, left, right, or bottom edges of every web page in the website.

During or after the design of the website, the actual web pages for the website are created using either wizards, templates, or HTML editors. Website templates are a set of premade icons and buttons and one or more web pages that allow a user to easily customize the overall appearance of the website. Templates allow the same theme to be used throughout the site as sub-pages are added. The user must use a text editor to enter the body or the content of each web page (usually text and graphics). The user may also specify one or more links to other pages and files within the body. A link is created by embedding a URL (uniform resource locator) as the address for the resource.

Although there are many software tools to create website, the tools only create static web pages that store each web page as a separate document. The problem with storing each web page as a separate document is that the HTML and other code for representing the links and content on the web pages must be duplicated on each web page that references common content. Not only does this waste storage space, but it also makes updating the website extremely tedious and error prone.

Accordingly, what is needed is an improved method for constructing and managing website. The present invention addresses such a need.

### SUMMARY OF THE INVENTION

The present invention provides a method and system for constructing a database driven website. The method and system include storing each web page as a database record having fields that reference a layout template and content, and storing the layout template and the content as database records. Each web page in the website may then be displayed by retrieving the fields in the corresponding records to access the layout template and content records for display.

The method and system further include allowing the website to include multiple types of web pages, called page-types. An application object is provided for each of the page types for processing the corresponding page type. When a web page is displayed, the record for the web page is retrieved from the database, causing the application object corresponding to the page type in the record to be invoked. The application object then accesses and processes the content record specified for the web page, and presents the content to a web browser according to the specified layout template.

According to the system and method disclosed herein, the present invention allows a user to define the organization of the website without specifying content; stores the code for processing each page type and content that is referenced by multiple web pages only once, and allows the user to dynamically change the layout, organization, and content of the website by simply updating the database records.

### BRIEF DESCRIPTION OF THE DRAWINGS

FIG. 1 is a block diagram illustrating a system for constructing a database-driven website in accordance with one preferred embodiment of the present invention.

FIG. 2 is as a flow chart illustrating the process for generating a database-driven website in accordance with a preferred embodiment of the present invention.

FIG. 3 is a block diagram illustrating an example organizational hierarchy for a website.

FIGS. 4A-4D are diagrams illustrating a preferred embodiment of a database schema for implementing the present invention.

FIG. 5 is a flow chart illustrating a process for creating database-driven web pages using preferred database schema.

FIGS. 6-12 are diagrams illustrating example screenshots of the website creation application as a user creates a web driven website in accordance with present invention.

FIG. 13 is a flow chart illustrating the process for displaying a web driven website in accordance with a preferred embodiment of the present invention.

### DETAILED DESCRIPTION

The present invention relates to methods for building, storing, and managing websites. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

The present invention provides a software tool, which in a preferred embodiment is implemented as a web-based application, for allowing a user to construct a website. Unlike prior website creation software tools, the present invention does not store the web pages of the website as separate files, thereby eliminating the duplication of code throughout the pages, and reducing storage space. According to present invention, each web page in the website is stored as a record in a database, rather than a separate file, and all the elements defining the web page, such as content and layout, are also stored and accessed from database tables. Therefore, when multiple web pages reference the same content, the content is not duplicated in each of the web pages, but is rather stored once in the database and accessed when each web page referencing the content is displayed.

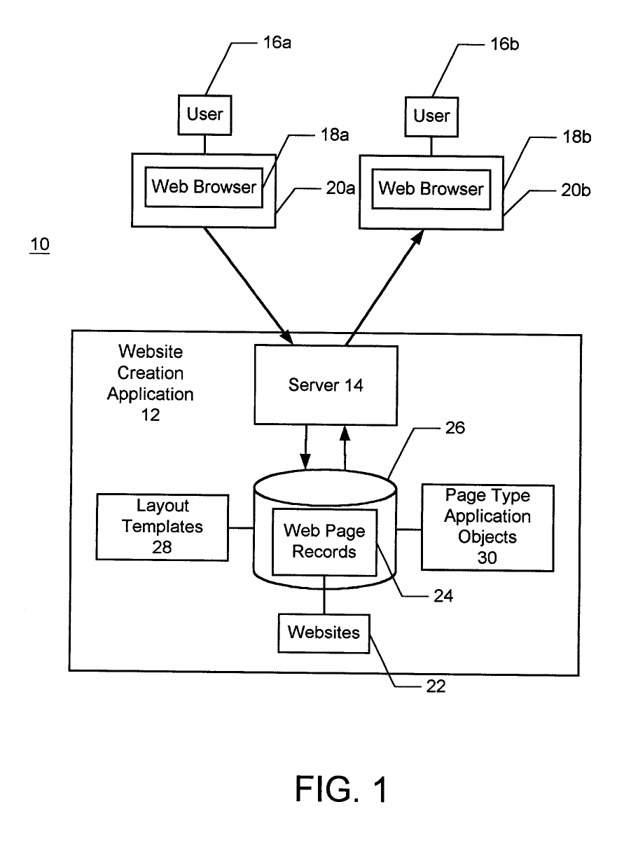

FIG. 1 is a block diagram illustrating a system for constructing a database-driven website in accordance with one preferred embodiment of the present invention. The system 10 includes a website creation application 12 running on a server 14 that is accessible over the Internet by one or more users 16 through a web browser 18 running on a client computer 20. The website creation application 12 leads the user 16a through a step-by-step process for creating a database-driven website 22. The website 22 is referred to as being database-driven because as the user 16a defines each web page, the web page is stored as a record 24 in a database 26. When the website 22 is to be displayed on a web browser 18b, the records 24 corresponding to the web pages are retrieved from the database 26 and presented to the web browser 14b.

The website creation application 12 provides multiple layout templates 28 to the user 16a for selection to aid in the construction of the website 22. Each layout template 28 defines locations for one or more navigational link areas, including a homepage link area that display navigational links for navigating the website 22. In a preferred embodiment, the navigational link areas appear on each page in the website 22.

The website creation application 12 also allows the user's website 22 to include multiple types of web pages, called page-types. In a preferred embodiment, there are two types of page-types; 1) applications, and 2) content, such as text and graphics. Examples of applications that can be included in a web page include a calendar, a calculator, web mail, a catalog, and a guestbook, for instance.

According to the present invention, an application object 30 is provided for each page type for processing the corresponding page type. As well known in the art, an application object 30 is a program similar to a DLL that is executed by a web server or an application server. Application objects 30 are typically associated with active server pages. When a web browser makes a request for web page that contains embedded code, the web server invokes the application object 30 and the application object 30 provides the processing for the page, such as delivering search data and on a web page, for example. Instead of storing a separate document for each web page in the website 22, the present invention stores a separate document for each type of web page in the website 22.

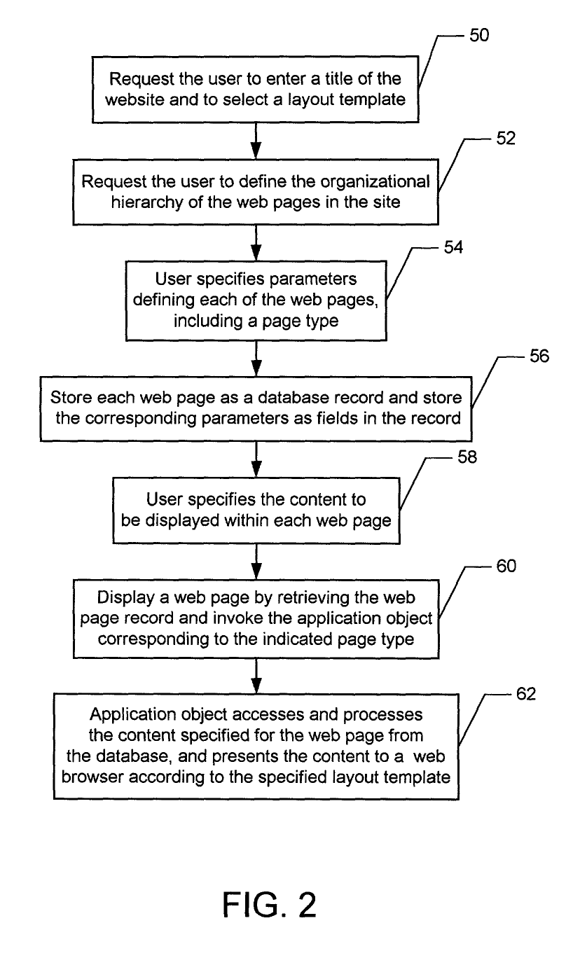

FIG. 2 is as a flow chart illustrating the process for generating a database-driven website 22 in accordance with a preferred embodiment of the present invention. Referring to both FIGS. 1 and 2, the website creation application 12 begins by requesting the user 16a to enter a name of the website 22 and to select a layout template 28 to apply to the website 22 in step 50. After a layout template 28 is selected for the website 22, the website creation application 12 requests the user 16a to define the organizational hierarchy of the web pages in the site, without the need to define content for each of the web pages in step 52. The organizational hierarchy generally defines how each web page links to the other web pages in the website 22. To define the organizational hierarchy of the website 22, the user 16a only needs to specify parameters for each of the web pages that define the structure of the website 22 in step 54, such as a title for the web page, the page type, and a link location.

The link location parameter specifies where a link for the web page will be displayed. The link location defines whether the link for a web page will appear in the navigational areas displayed on every page, or rather that the web page is a sub-page of another web page, in which case the link for the web page may only appear when the parent web page is displayed.

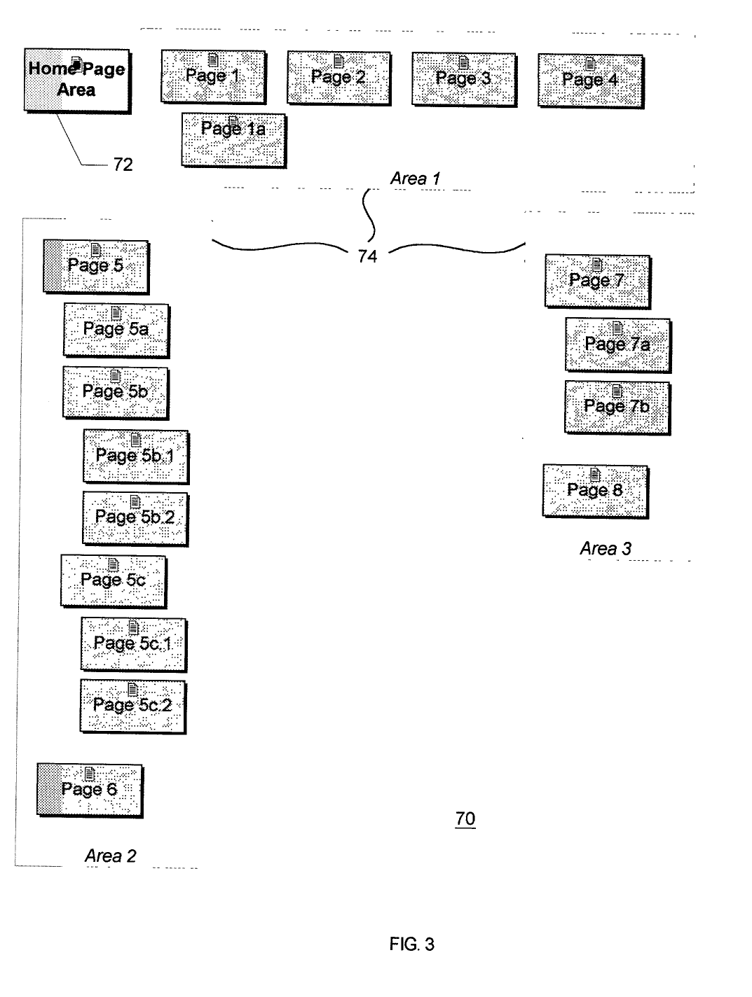

FIG. 3 is a block diagram illustrating an example organizational hierarchy for a website 22. In the example, the user 16a has chosen a layout 70 for the website 22 that displays one homepage link area 72 and three navigational link areas 74 (areas 1 through 3). As shown, area 1 displays links for web pages one through four, area 2 displays links for pages five and six, and area 3 displays links for pages seven and eight. The links for the sub-pages are not displayed in the navigational link areas unless the parent page is currently being displayed. For example, the links for pages 5a, 5b, and 5c are only displayed in area 2 when a user is viewing page 5. Likewise, links for pages 5b.1 and 5b.2 may only be displayed when page 5b is being viewed.

Referring again to FIG. 2, after the user defines the required parameters for each web page, the website creation application 12 stores each web page as a database record 24 and stores the corresponding parameters as fields in the record 24 in step 56. After the user has finished defining the organizational hierarchy, the user may go back and specify the content to be displayed within the web page in step 58.

Thus, according to the present invention, by specifying only the parameters and a layout, the user can create the structure for the entire website 22, without having to specify the content, although the content is also a parameter that may be optionally specified when the web page is created.

When a web page from the website 22 is to be subsequently displayed on a web browser 18b, the record 24 for the web page is retrieved from the database 26 and the application object 30 corresponding to the indicated page type is invoked in step 60. The application object 30 then accesses and processes the content specified for the web page from the database 26, and presents the content to the web browser 18b according to the specified layout template in step 62.

The method for constructing a website by storing the web pages as database records offers several advantages, which include:

1) the organization of the website can be created without specifying content,

2) when the content is specified, the content which is common across several web pages is stored only once,

3) the code for creating and displaying common page types are stored only once, and

4) the layout, organization, and content of the website may be changed dynamically by updating the database records.

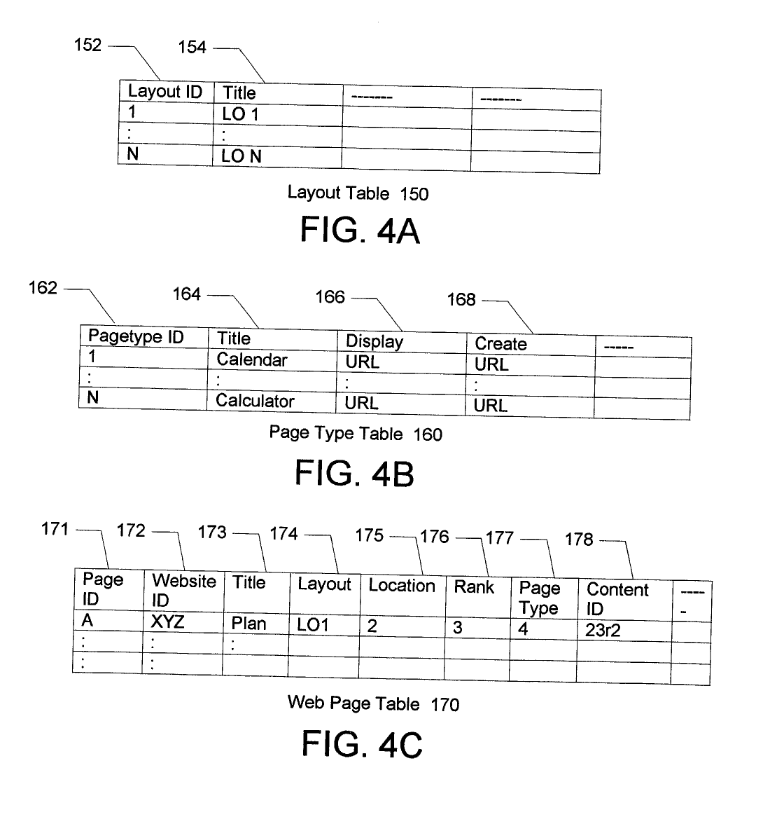

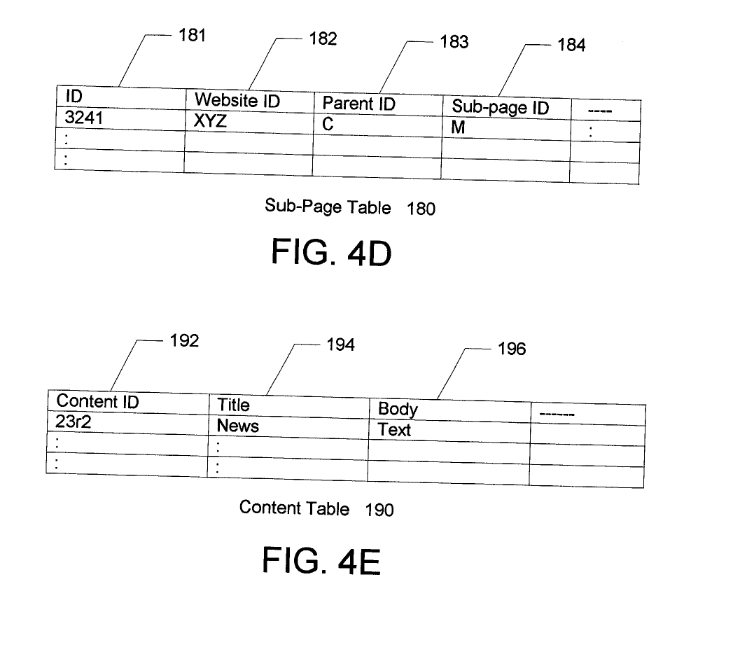

Referring now to FIGS. 4A-4D, a preferred embodiment of a database schema for implementing the present invention is shown. In order to generate the database-driven website 22, the present invention utilizes a database schema that includes a layout table 150, a page type table 160, a web page table 170, a sub page table 180, and a content table 190.

The layout table 150 and the page type table 160 are system tables that are accessed by each website 22 created in the system 10. The layout table 150 includes a record for each layout template 28 provided in the system. The layout table 150 includes a layout ID field 152 and a title field 154 for identifying the particular layout template 28. The layout table 150 may also include other fields for specifying other parameters, such as a color scheme.

The page type table 160 includes a record for each page type provided in system. The page type table 160 includes a page type ID field 162 and a title field 164 for identifying the particular page type. The page type table 160 also includes a display field 166 and a create field 168 that specify a URL for the application object 30 responsible for displaying and configuring the web page, respectively.

The web page table 170 includes a record for each web page created for a particular website 22. The web page table 170 includes a page ID field 171, a website ID field 172, and a title field 173 for identifying the web page. The web page table 170 further includes a layout field 174, a location field 175, a rank field 176, a page type field 178, and a content ID field 179. The layout field 174 references the layout table 150 and contains a value corresponding to the layout template 28 chosen by the user. The location field 175 contains a value corresponding to a navigational area 74 within the chosen layout defining where a link to the current page will be displayed. The rank field 176 specifies the order in which the link for the web page will be displayed in the navigational area. The page type field 177 references the page type table 160 and contains a value corresponding to the page type chosen by the user. The content ID field 178 references the content table 190 and specifies the content to be displayed within the web page. The web page table 170 may also include other fields for specifying security and logging parameters, for example.

The sub-page table 180 keeps track of the parent/sub-page relationships between web pages. The sub page table 180 includes a unique ID field 181 for identifying the web page, the website ID field 182 for identifying the website 22, a parent ID field 183 for identifying the parent web page, a sub-page ID field 184 identifying the sub-page, and a rank field 185 for specifying the order of the sub-page within the parent web page.

The content table 190 is responsible for storing the content associated with the web pages. The content table 190 includes a content ID field 192, a title field 194 for identifying the content, and a body field 196 for storing the body of the content. The content table 190 may also include many other fields, which is outside the scope of this description.

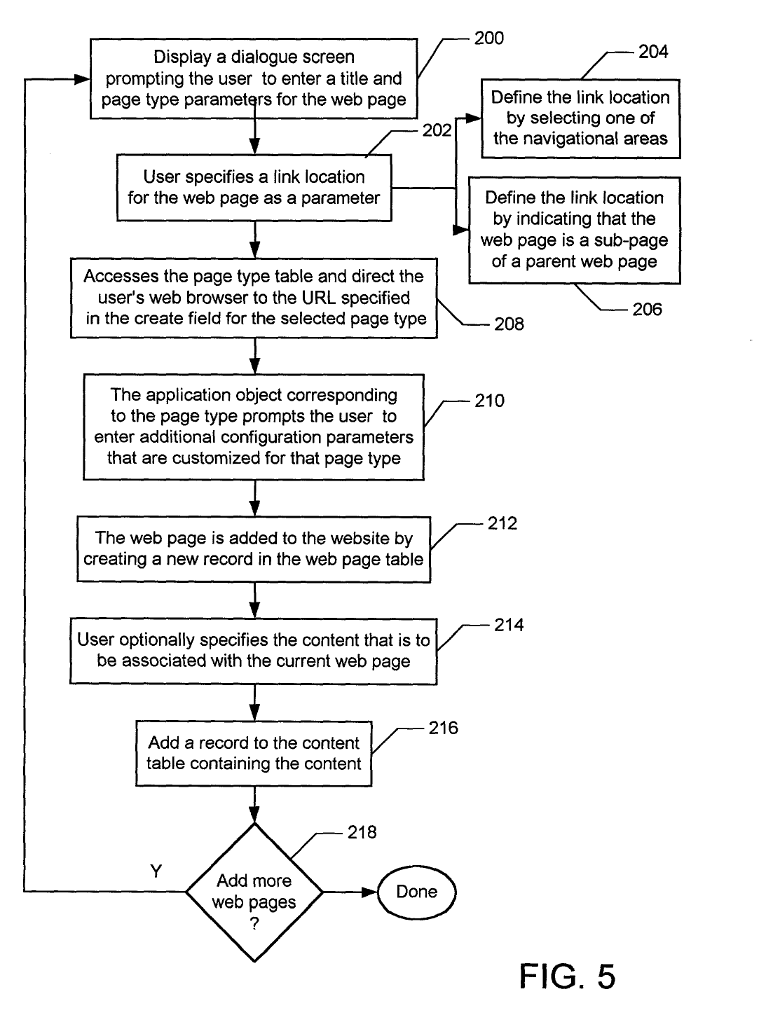

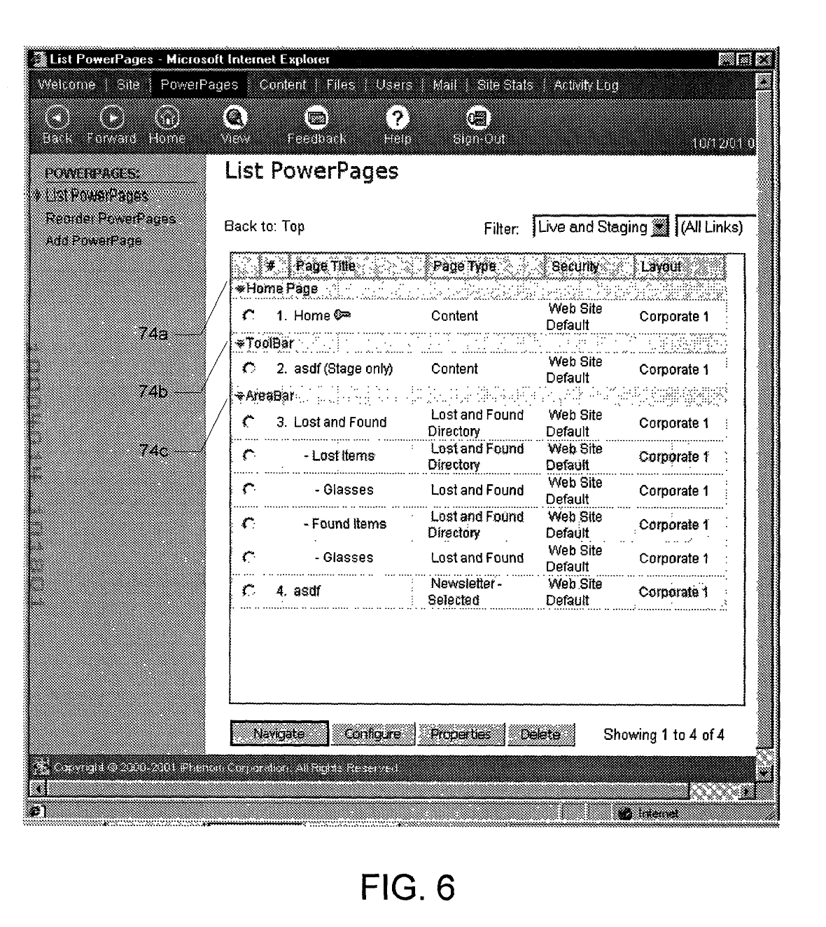

FIG. 5 is a flow chart illustrating a process for creating database-driven web pages using the database schema described above and will be discussed with reference to FIGS. 6-12. FIGS. 6-12 are diagrams illustrating example screenshots of the website creation application 12 as a user 16 creates a web driven website 22 in accordance with present invention.

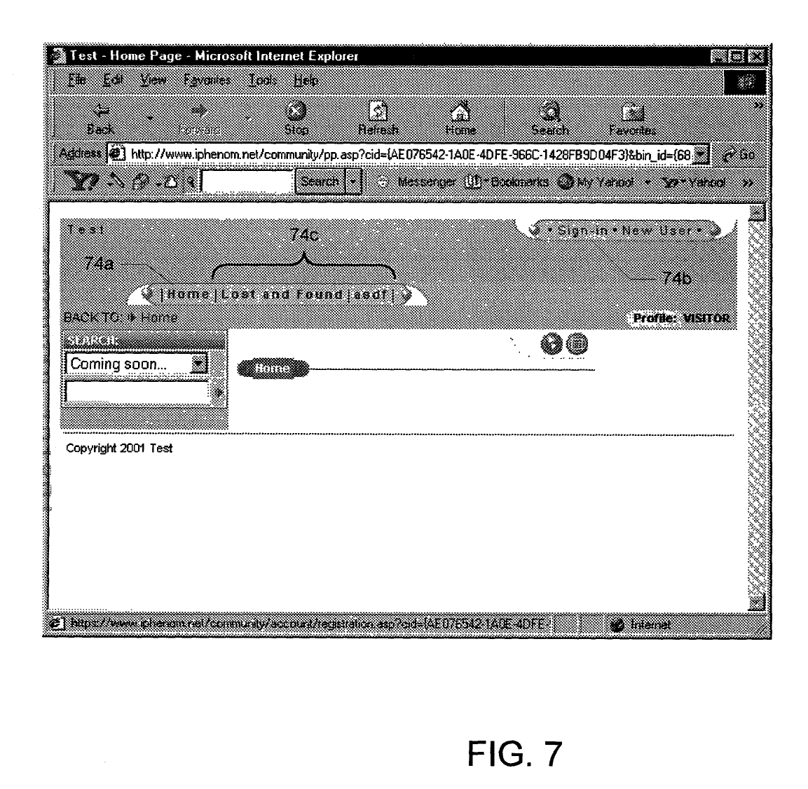

FIG. 6 shows a screen in the website creation application 12 that shows the web page hierarchy created for a website 22, including several navigational areas 74a, 74b, and 74c (collectively referred to as 74). FIG. 7 shows a top-level web page of the website 22 when displayed in a web browser. In this example, the database-driven web pages are referred to as PowerPages, and the user 16 has chosen a layout template 28 called “corporate 1” for the website 22 that includes a homepage link area 74a, a “toolbar” navigational link area 74b, and an “area” bar navigational link area 74c.

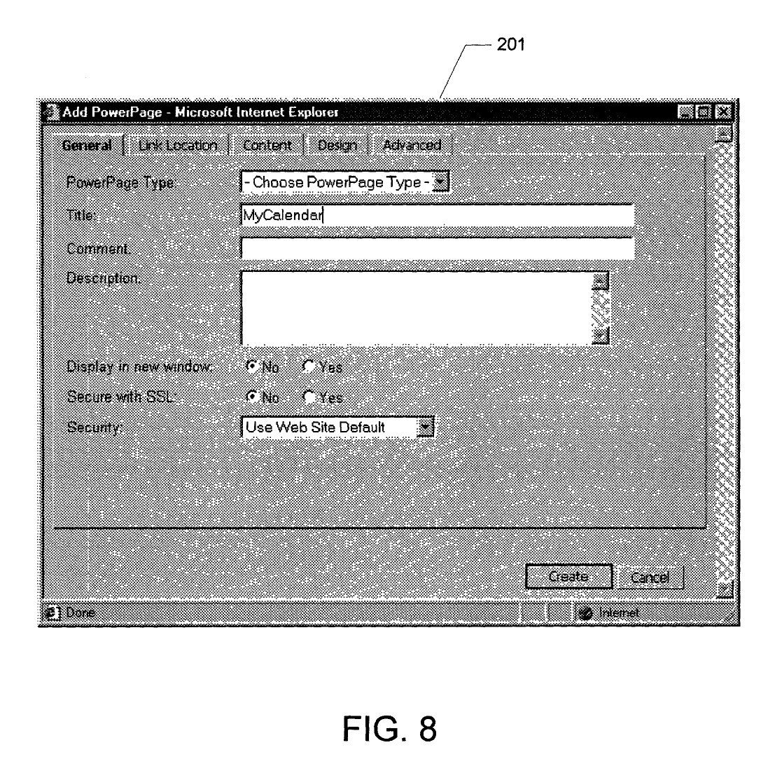

Referring to FIG. 5, when the user 16 clicks an “Add PowerPage” link from the “List Power Pages” screen an Add PowerPage dialogue screen is displayed in step 200 prompting the user 16 to enter the title of the web page and the page type parameters for the web page. An example Add PowerPage screen 201 is shown in FIG. 8. In this example the user 16 is specifying that the PowerPage will be a calendar page type, and has entered a title of “MyCalendar.”

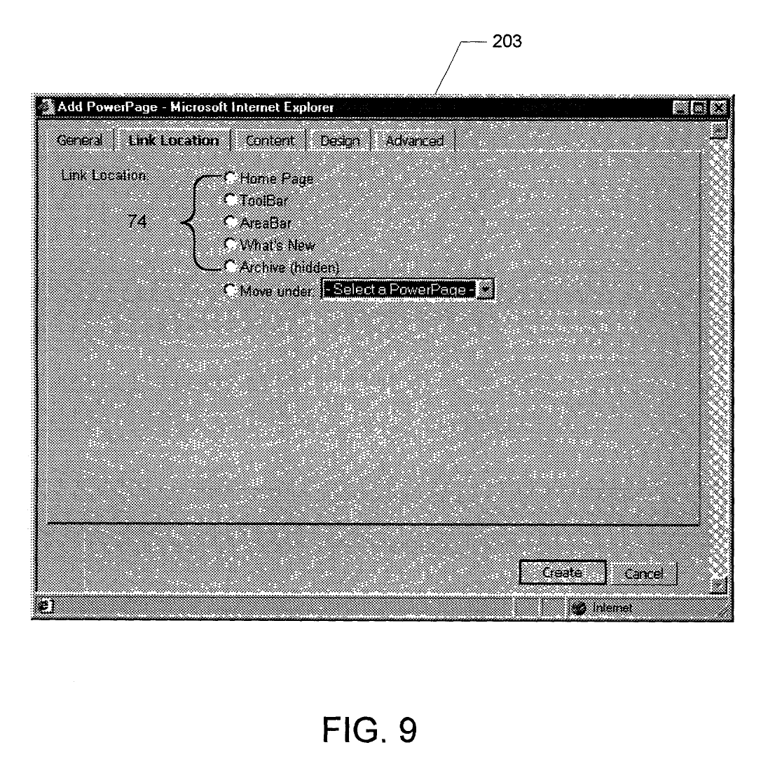

Referring again to FIG. 5, the user 16 must also specify the link location for the web page as one of the parameters in step 202. This may be done by selecting the link location tab, which causes a link location dialogue screen to appear. FIG. 9 shows an example link location dialogue screen 203. Referring again to FIG. 5, the user 16 defines the link location by either selecting one of the navigational areas 74 from a list in step 204, or by defining the link location as a parent/child relationship by specifying that the web page is a sub-page of a previously defined parent web page in step 206.

After the user 16 selects a page type, the website creation application 12 accesses the page type table 160 and directs the user's web browser 18 to the URL specified in the create field 168 for the selected page type in step 208. The application object 30 responsible for creating the corresponding page type prompts the user 16 to enter additional configuration parameters that are customized for that page type in step 210. For example, if the page type is text, then the application object 30 may prompt the user 16 to enter URLs to external sources, for instance.

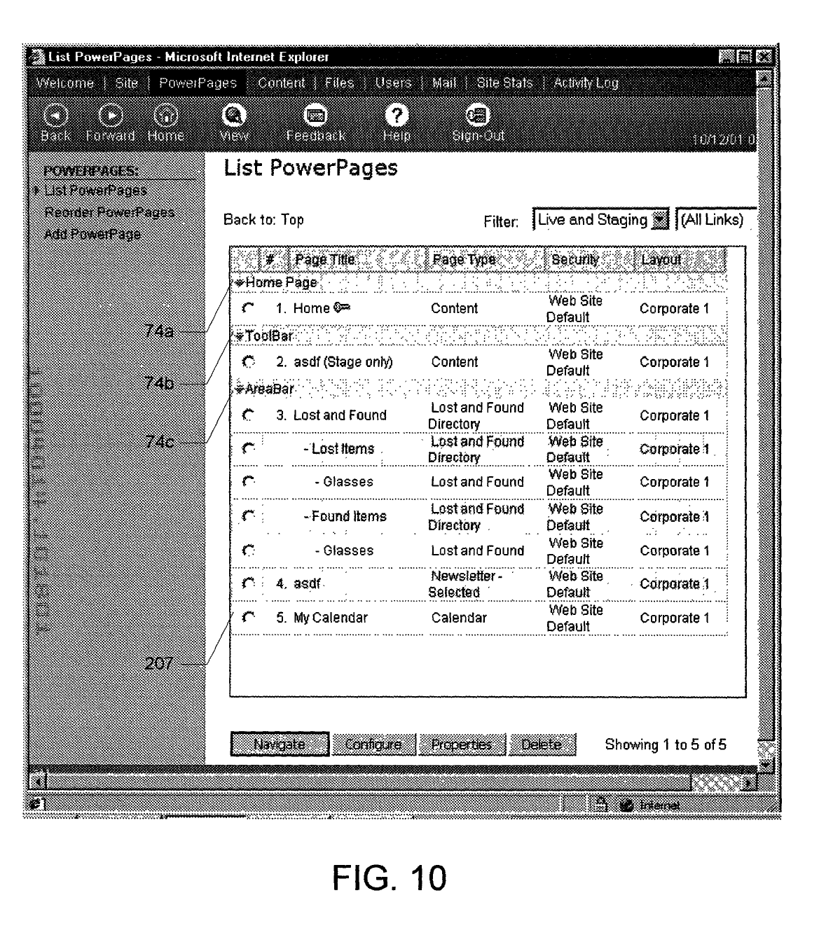

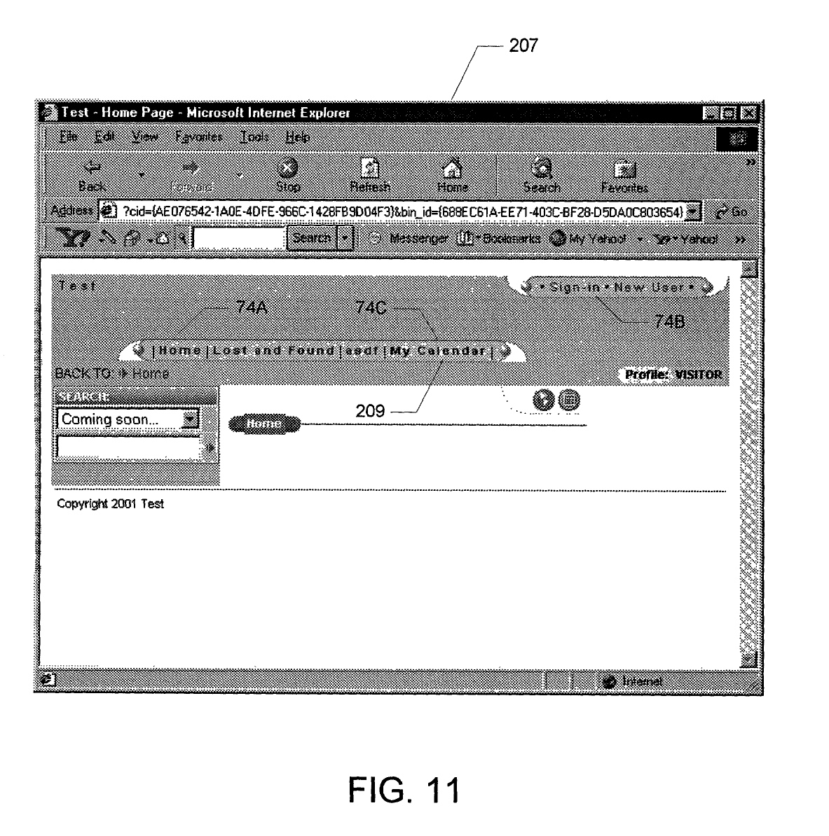

Once the user 16 has specified the minimum set of parameters, the web page is added to the website 22 by creating a new record in the web page table 170 in step 212. In the present example, after the user 16 has chosen the page type and link location for the “MyCalendar” web page, the “MyCalendar” web page 207 will appear on the “List PowerPages” screen, as shown in FIG. 10. When one of the top-level web pages is displayed in the web browser 18, a “MyCalendar” web page link 209 is displayed in the “area bar” navigational area 74c, as shown in FIG. 11.

Referring again to FIGS. 5 and 8, after the user 16 has specified the minimum set of parameters, the user 16 may optionally specify the content that is to be associated with the current web page in step 214 by clicking the content tab. When the user 16 specifies the content for the web page, the website creation application 12 adds a record to the content table 190 containing the content in step 216. Whether or not the user 16 adds content, the user 16 may continue adding web pages to the website 22 by clicking the “Add PowerPage” link in step 218.

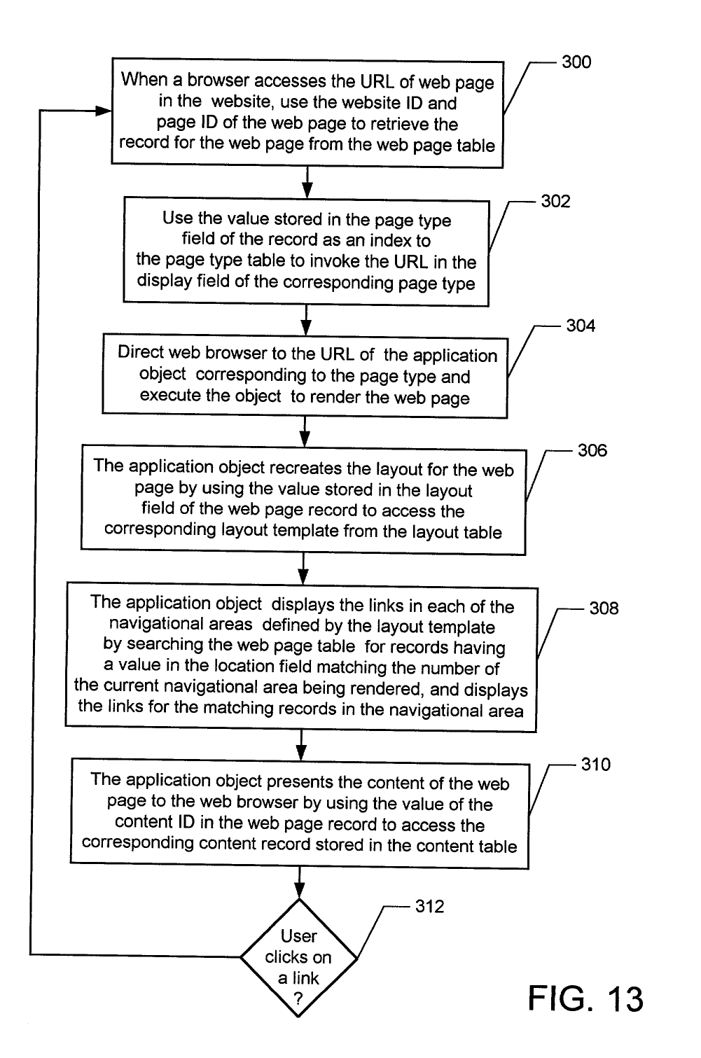

FIG. 13 is a flow chart illustrating the process for displaying a web driven website 22 in accordance with a preferred embodiment of the present invention. Once a web browser 18 on a client computer 20 accesses the URL of a web page in the website 22, the website ID 171 and page ID 172 of the web page are used to retrieve the record for the web page from the web page table 170 in step 300.

The value stored in the page type field 176 of the record is used as an index to the page type table 160 to invoke the URL in the display field 166 in step 302. The web browser 18 is then directed to the URL of the application object 30 corresponding to the page type, and the application object 30 is executed to render the web page in step 304. The application object 30 recreates the layout for the web page by using the value stored in the layout field 174 of the web page record to access the corresponding layout template 28 from the layout table 150 in step 306. The application object 30 displays the links in each of the navigational areas 74 defined by the layout template 28 in step 308 by searching the web page table 180 for records having a value in the location field 175 matching the number of current navigational area 74 being rendered, and displays the links for the matching records in the navigational area 74. The order that the links are displayed is based on the value in the rank field 176 of the matching records.

The application object 30 also presents the content of the web page to the web browser 18 by using the value of the content ID 178 in the web page record to access the corresponding content record stored in the content table 190 in step 310. The process for displaying a database-driven web page is repeated each time the user clicks on a link within the website 22 in step 312.

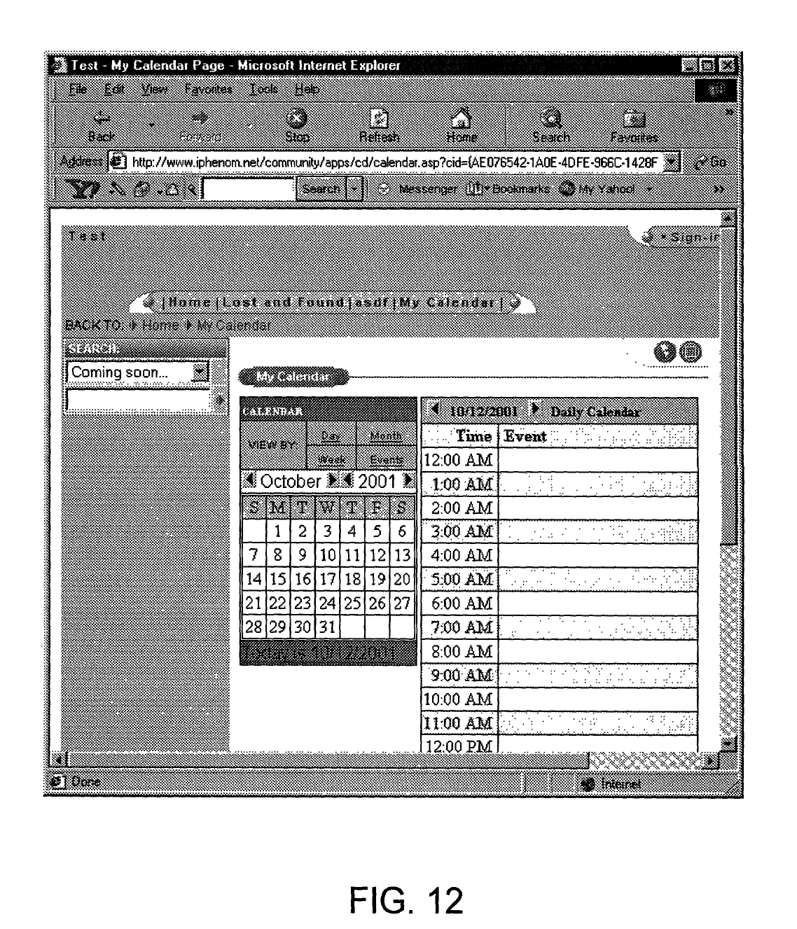

Referring again to the example website 22, FIG. 12 shows the result of the user 16 clicking on the “MyCalendar” link 209 displayed in the area bar navigational area 74b shown in FIG. 11. Clicking the link invokes the application object 30 corresponding to the calendar page type, which generates the calendar on the web page in accordance with the layout template 28 specified for that web page.

Every content page stored in the content table 190 is displayed by one of the application objects 30. Therefore, although all page-types pre-exist as application objects 30, if a particular website 22 does not use all available page-types, then the application objects 30 for the unused page-types will not be invoked. However, because all of the page-types do pre-exist, the user may easily add a new page type to his/or her website 22 without having to write the code to display the content.

In addition, because different layout templates will display a web page differently (e.g., a particular layout may not display a left navigational area), the user may change the look and feel for the entire website 22 dynamically by merely changing the value of the layout field.

If any pages have content that includes links to external content, and those links are repeated on many pages of the website 22, then the user can modify the link on all web pages by updating the URL in the corresponding record of the content table 190. Once the link is changed, the modification will appear on every website 22 that references the link. This is a more efficient process than updating static links by hand on each web page.

A method and system for constructing a database-driven website has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1 A method for constructing a database driven website, the method comprising steps of:
(a) storing each web page as a database record having fields that reference a layout template and content;
(b) storing the layout template and the content as database records; and
(c) displaying each web page by using the fields in the corresponding database record to access the layout template and content records for display.

2 The method of claim 1 further including the step of: allowing the user to specify a page-type for each web page from among a plurality of page types.

3 The method of claim 2 further including the step of: storing the specified page type as a field in the record for the page type.

4 The method of claim 3 further including the step of: providing an application object for each respective page type for processing the page-types when invoked.

5 The method of claim 4 further including the step of: when displaying the web page, accessing the page type field and invoking the corresponding application object to display the web page.

6 The method of claim 5 further including the step of: comprising the page-types as application page-types and content page-types.

7 The method of claim 1 further including the step of: defining, in each layout, template locations for one or more navigational link areas that display navigational links for navigating the website.

8 The method of claim 7 further including the step of: storing each web page as a record in response to a user specifying parameters for the web page, wherein the parameters specify a title for the web page, a layout template to apply to the web page, and a link location that defines where a link for the current web page should be displayed.

9 The method of claim 8 further including the step of: defining by the link location whether the link for a web page will appear in the navigational areas displayed on every page, or that the current web page is a sub-page of a parent web page, in which case the link for the current web page may only appear when the parent web page is displayed.

10 A method for constructing a database-driven website, the method comprising the steps of:
(a) providing a plurality of application objects corresponding to a plurality of page-types for processing the page-types when invoked;
(b) allowing the user to create one or more web pages for the website by specifying parameters for each of the web pages, wherein the parameters include the page-type of the web page, and content to be displayed in the web page;
(c) storing each web page as a database record and storing the corresponding parameters as fields in the record; and
(d) displaying one of the web pages on a client computer by invoking the application object indicated in the page type fields in each of the web page records to present the corresponding content to the client computer.

11 The method of claim 10 wherein step (a) further includes the step of:
(i) providing a plurality of layout templates defining locations of navigational areas that display navigational links on web pages.

12 The method of claim 11 wherein step (b) further includes the step of:
(i) allowing the user to select one of the layout templates, and to specify a link location.

13 The method of claim 12 wherein step (d) further includes the step of: accessing the specified layout template to display links to other web pages on the web page.

14 The method of claim 13 further including the step of: defining by the link location whether the link for a web page will appear in the navigational areas displayed on every page, or that the current web page is a sub-page of a parent web page, in which case the link for the current web page may only appear when the parent web page is displayed.

15 The method of claim 10 further including the step of: allowing the user to specify content both during and after specifying the parameters for each web page.

16 The method of claim 10 further including the step of: providing a software tool for allowing the user to construct the website.

17 The method of claim 16 further including the step of: implementing the software tool as a web application running on a server that allows the user to construct the website using a web browser.

18 A method for providing database-driven web pages, the method comprising the steps of:
(a) providing a plurality of layout templates defining locations of navigational areas that display navigational links on web pages;
(b) providing a plurality of page types defining the type of web page, wherein each page type includes an application object for processing the web page;
(c) allowing a user to define an organizational hierarchy for the website by specifying parameters for each of web pages, wherein the parameters include one of the layout templates, a title for the web page, one of the page types, and a link location;
(d) storing with web page as a database record that includes fields for storing the specified parameters; and
(e) displaying each web page by accessing the database record for the web page, and invoking the application object corresponding to the specified page type to render the web page according to the specified layout template.

19 The method of claim 18 further including the step of: defining by the link location whether the link for a web page will appear in the navigational areas displayed on every page, or that the current web page is a sub-page of a parent web page, in which case the link for the current web page may only appear when the parent web page is displayed.

20 The method of claim 19 further including the step of: allowing the user to specify content for each of the web pages, and storing the content as a database record.

21 The method of claim 20 further including the step of: allowing the user to specify content both during and after specifying the organizational hierarchy for the website.

22 The method of claim 21 further including the step of: providing a software tool for allowing the user to construct the website.

23 The method of claim 22 further including the step of: providing the software tool as a web application running on a server that allows the user to construct the website using a web browser.

24 A method for constructing a website that includes a plurality of web pages wherein top-level web pages, including a homepage, display a set of navigational links for accessing other web pages, the method comprising the steps of:
(a) in response to a user requesting to create a website, selecting a layout template that defines the homepage and navigational areas on the top-level web pages for displaying the navigational links; and
(b) defining the top-level web pages by
(i) allowing the user to specify parameters for each of the top-level web pages,
(ii) allowing the user to specify a link location for each of the top-level web pages, wherein the link location defines either which navigational area a link to the top-level web page will be displayed, or that the top-level web page is a sub-page of apparent top-level web page, such that the parent top-level web page will display a navigational link to the sub-page, and
(iii) storing each of the top-level web pages as a database record, and storing the corresponding parameters as fields in the record.

25 The method of claim 24 wherein step further includes the step of: allowing the user to specify a page type and content for each of the top-level web pages.

26 The method of claim 25 wherein step further includes the step of: storing a plurality of page types as database records for user selection, and storing the content for each of the top-level web pages as database records.

27 The method of claim 26 further including the step of: providing a plurality of application objects corresponding to each page type for processing the page-types when invoked.
